(19) United States
(12) Patent Application Publication
(10) Pub. No.: US 2001/0050471 A1
(43) Pub. Date: Dec. 13, 2001

(54) Hitch receiver assembly with AC and/or DC utility outlet

(76) Inventors: Richard W. McCoy, Granger, IN (US); Thomas W. Lindenman, South Bend, IN (US)

Correspondence Address: KING & SCHICKLI, PLLC, 247 NORTH BROADWAY, LEXINGTON, KY, 40507, US

(21) Appl. No.: 09/864,027

(22) Filed: May 23, 2001

Related U.S. Application Data
(60) Provisional application No. 60/209,273, filed on Jun. 2, 2000.

(51) Int. Cl. B60D 1/62

(52) U.S. Cl. 280/504; 280/422

(57) ABSTRACT

A trailer hitch receiver assembly includes a frame member with a hitch receiver box, at least one mounting bracket carried on the frame member for securing the frame member to a towing vehicle and a utility power outlet. The utility power outlet may be a DC outlet, an AC outlet or both.

This application claims the benefit of U.S. Provisional Application Serial No. 60/209,273 filed Jun. 2, 2000.

### TECHNICAL FIELD

The present invention relates generally to trailer hitch receiver assemblies and, more particularly, to a trailer hitch receiver assembly incorporating an integral AC and/or DC utility power outlet which may be used to power any number of electrical accessories, devices and/or equipment as desired.

### BACKGROUND OF THE INVENTION

It has long been known to construct towing hitches that are mounted to vehicles in order to allow the towing of trailers or the like. In recent years, such hitches have been designed to include a receiver box having a rearwardly directed opening or cavity for the receipt of a hitch or draw bar that carries a hitch ball or other means allowing connection to a trailer. Examples of such a structure include U.S. Pat. No. 3,768,837 to Reese and U.S. Pat. No. 5,620,198 to Borchers, both owned by Reese Products, Inc., the Assignee of the present invention.

Many of these trailer hitch receiver assemblies also include a wiring harness and an appropriate plug to allow electrical connection between the electrical system of the towing vehicle and the operating lights of a trailer to be towed behind the towing vehicle as well as to the trailer brakes if the trailer is so equipped. Trailer hitch receiver assemblies have, however, not been previously equipped with a DC and/or AC utility power outlet. Such a power outlet could be used to conveniently connect and operate a utility light, electric power tools, a television and/or any other electrical appliance desired by the towing vehicle operator.

### SUMMARY OF THE INVENTION

A trailer hitch receiver assembly is provided incorporating a power outlet used to power substantially any electrical device which may be desired by the user. The trailer hitch receiver assembly is characterized by a reliable, yet relatively inexpensive construction incorporating an integral DC utility power outlet, an AC utility power outlet or both AC and DC utility power outlets which may be utilized to power substantially any electrical device needed by the operator including, for example, a utility light, electrical power tools such as drills, saws, sanders, grinders and the like, electrical appliances such as televisions and radios or any other electrical device capable of operation with 12 volt DC and/or 110 volt AC power.

Additional advantages and other novel features of the invention will be set forth in part in the description that follows and in part will become apparent to those skilled in the art upon examination of the following or may be learned with the practice of the invention. The advantages of the invention may be realized and obtained by means of the instrumentalities and combinations particularly pointed out in the appended claims.

To achieve the foregoing, and in accordance with the purposes of the present invention as described herein, an improved trailer hitch assembly is provided. The trailer hitch assembly includes a frame member including a hitch receiver box, at least one mounting bracket carried on the frame member for securing the frame member to the vehicle, and a utility power outlet. The utility power outlet may be a DC power outlet. Alternatively, it may be an AC power outlet. Still further, the hitch receiver assembly may include both DC and AC utility power outlets. In one embodiment, the power outlet or outlets are carried on the frame member. Further, the power outlets may include a hinged cover to prevent dirt and moisture from entering the outlets when not in use.

In accordance with yet another aspect of the present invention, a method of powering an electrical device or appliance from a trailer hitch receiver is provided. That method may be broadly defined as including the steps of providing a trailer hitch receiver assembly with a utility power outlet and powering the utility power outlet from the towing vehicle to which the trailer hitch receiver assembly is connected. In this way, either or both DC and AC power may be provided to power substantially any electrical device or appliance that might be desired no matter what the application or occasion.

Still other objects of the present invention will become apparent to those skilled in this art from the following description wherein there is shown and described a preferred embodiment of this invention, simply by way of illustration of one of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWING

The accompanying drawing incorporated in and forming a part of the specification, illustrates several aspects of the present invention and together with the description serves to explain the principles of the invention. In the drawing:

FIG. 1 is a perspective view of the trailer hitch assembly of the present invention;

FIG. 1 a is a side elevational view of the trailer hitch assembly of FIG. 1;

FIG. 1b is a rear elevational view of the trailer hitch assembly of FIGS. 1 and 1a;

FIG. 2 is a schematical view of a wiring circuit of the present invention;

FIG. 3 is a perspective view of a first alternative embodiment of the present invention incorporating only a DC utility power outlet; and

FIG. 4 is a perspective view of another alternative embodiment of the present invention incorporating only an AC utility power outlet.

Reference will now be made in detail to the present preferred embodiments of the invention, examples of which are illustrated in the accompanying drawings.

### DETAILED DESCRIPTION OF THE INVENTION

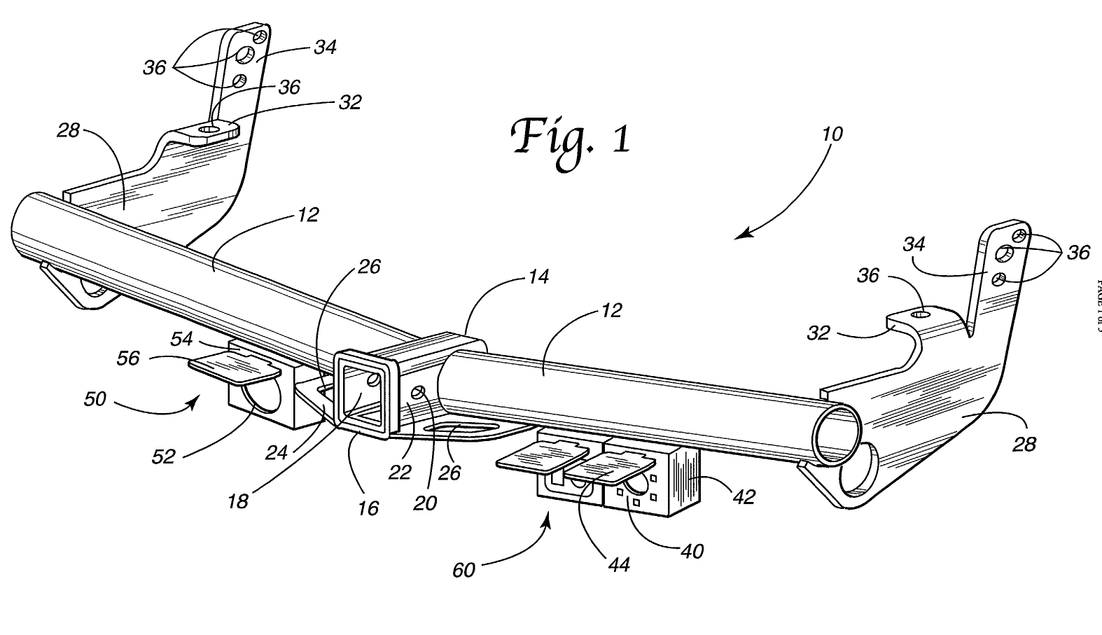

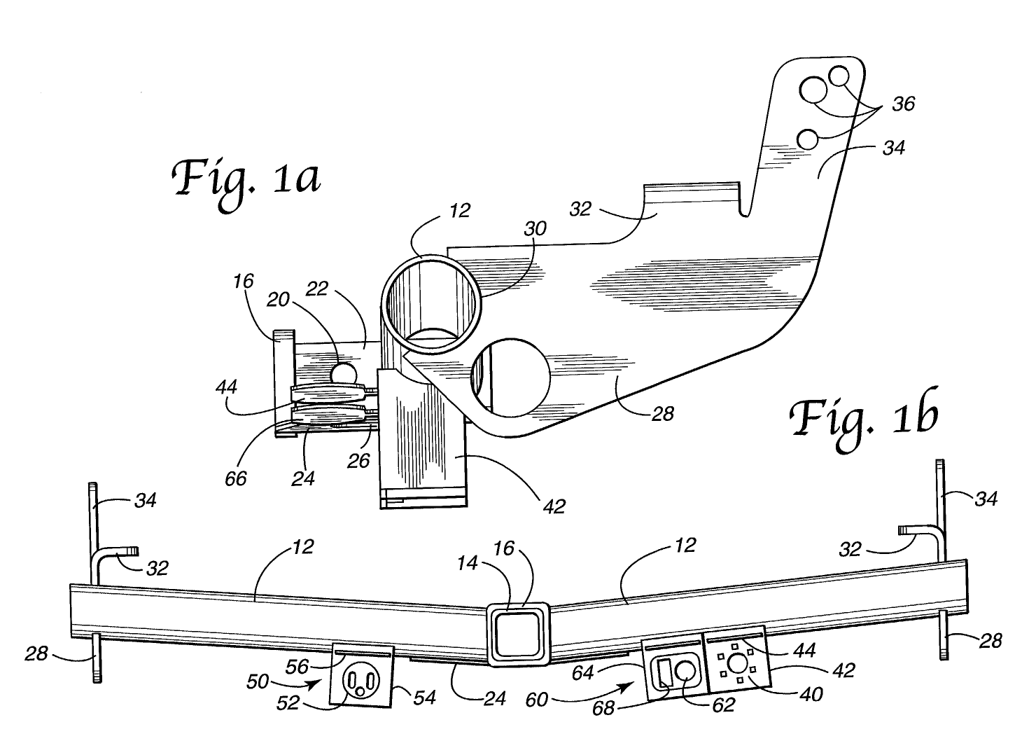

Reference is now made to FIGS. 1, 1a and 1b showing a trailer hitch assembly 10 of the present invention. The trailer hitch assembly 10 includes a frame member or cross member preferably formed from a pair of tubular steel sections 12 welded to the side walls of a centrally located receiver box 14 so as to project outwardly in substantially opposing directions. The tubular steel sections may be formed with a round cross section as shown in the drawing figures, an elliptical cross section, a square cross section or any other appropriate shape providing the necessary strength to function as a trailer hitch assembly.

The receiver box 14 includes a reinforced lip 16 defining an opening leading to a hitch bar receiving cavity 18. Aligned apertures 20 in the opposing side walls 22 of the receiver box 14 allow the secure connection of a hitch bar in the receiver box 14 in a manner well known in the art by means of a connecting pin and cooperating pin clip (not shown). A chain plate 24 of steel material is welded to the receiver box 14 and tubular steel sections 12 in order to strengthen the connection. As is know in the art, chain plate 24 includes two apertures 26. The safety chains of a trailer may be connected to the chain plate 24 through engagement in these apertures 26.

Vehicle mounting brackets 28 are mounted adjacent the distal end of each tubular section 12. More specifically, each mounting bracket 28 includes a notch 30 sized and shaped to receive the tubular section 12. The brackets 28 are welded to the tubular sections 12 in order to complete the connection. The mounting brackets 28 each include a mounting flange 32 and an upwardly projecting mounting lug 34, both with apertures 36. Nut and bolt fasteners (not shown) are extended through these apertures 36 and cooperating apertures drilled in the frame of the towing vehicle in order to mount the trailer hitch assembly 10 thereto.

Of course, the arrangement of the mounting flanges 32 and/or mounting lugs 34 will vary from hitch assembly to hitch assembly in order to correspond to the frame of the make and model of vehicle to which the hitch assembly is to be mounted. As such, the arrangement and orientation of the flanges 32 and lugs 34 in the drawing figures are to be considered as illustrative in nature and not as restrictive.

The trailer hitch assembly 10 also carries a trailer light plug 40 such as a standard recreational vehicle 7-way harness plug. As is known in the art, this plug allows connection of the electrical system of the towing vehicle to the various trailer lights and the trailer brakes if the trailer includes such brakes. Plug 40 may be housed in a weather proof box 42 including a hinged cover 44.

Additionally, the trailer hitch assembly 10 carries an AC utility power outlet 50 comprising a receptacle 52 adapted to receive a standard two prong male plug or three prong grounded plug. The receptacle 52 is housed in a weather resistant box 54 mounted on a section 12 of the central frame member. The box 54 includes a hinged door or cover 56. When the cover 56 is closed, the box 54 and cover 56 function to protect the receptacle 52 from dirt and moisture.

Still further, the trailer hitch assembly 10 carries a DC utility power outlet 60 comprising a receptacle 62 such as a standard 12 volt DC power receptacle adapted to receive a standard 12 volt power plug (i.e. a cigarette lighter plug). The receptacle 62 is housed in a weather resistant box 64 mounted on a section 12 of the central frame member. The box 64 includes a hinged door or cover 66. When the cover 66 is closed, the box 64 and cover 66 function to protect the receptacle 62 from dirt and moisture. Of course, either or both of the utility power outlets 50, 60 may include an on/off switch 68 such as illustrated in FIG. 1b.

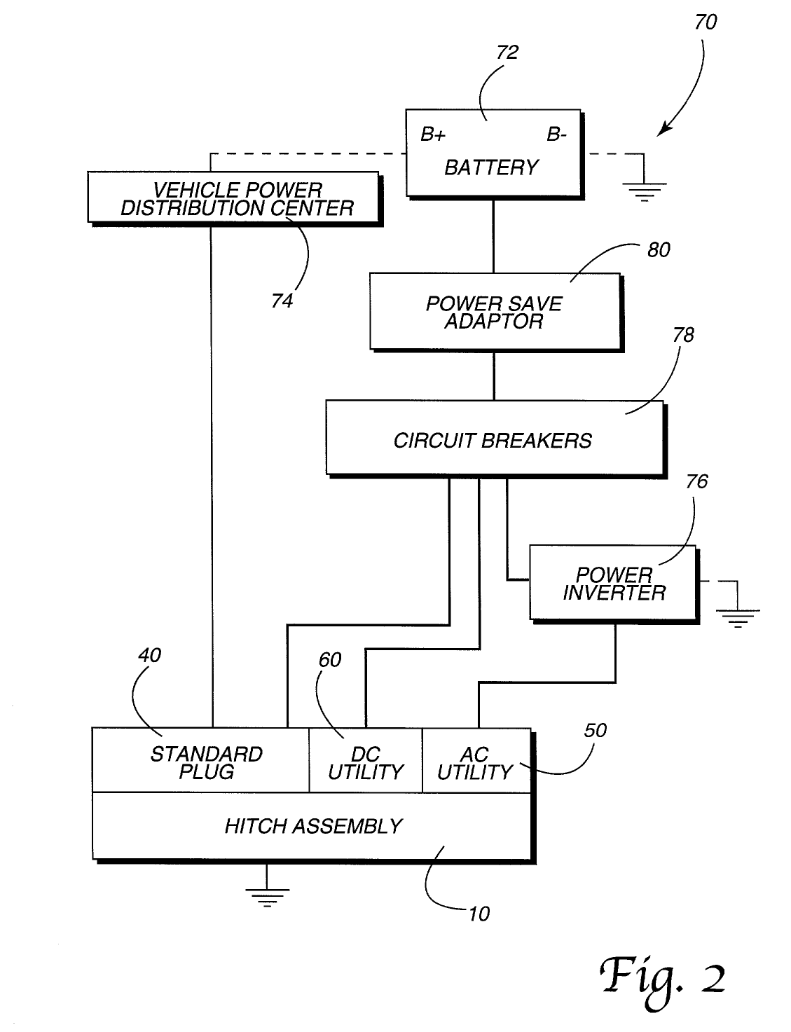

Reference is now made to FIG. 2 showing a schematical illustration of the wiring circuit 70. Shown is the vehicle battery 72 as well as the standard vehicle power distribution center 74. Also shown are the 7-way standard plug 40 for powering trailer light and brake functions, the 12 volt DC utility power outlet 60 and the 110 volt AC utility power outlet 50 all carried on the trailer hitch assembly 10. The AC utility power outlet 50 is connected to a power invertor 76 for converting 12 volt DC input to 110 volt AC output. By running the vehicle motor during use of the AC power outlet 50, it is possible to generate up to 20 amps of current for powering any number of electrical devices such as power tools at a construction site or a refrigerator, T.V., lights and/or radio at a campsite. A bank of fuses or circuit breakers 78 provides for circuit overload protection. The circuit 70 may also include a low battery power save adapter 80 to cut power to the utility outlets 50, 60 and save sufficient battery power for starting the towing vehicle.

In summary, numerous benefits result from employing the concepts of the present invention. Through the provision of the AC and DC utility power outlets 50, 60, one may connect and conveniently power a nearly infinite number of different electrical devices and appliances as needed or desired. Accordingly, the benefits of the present invention are as boundless as the user's imagination.

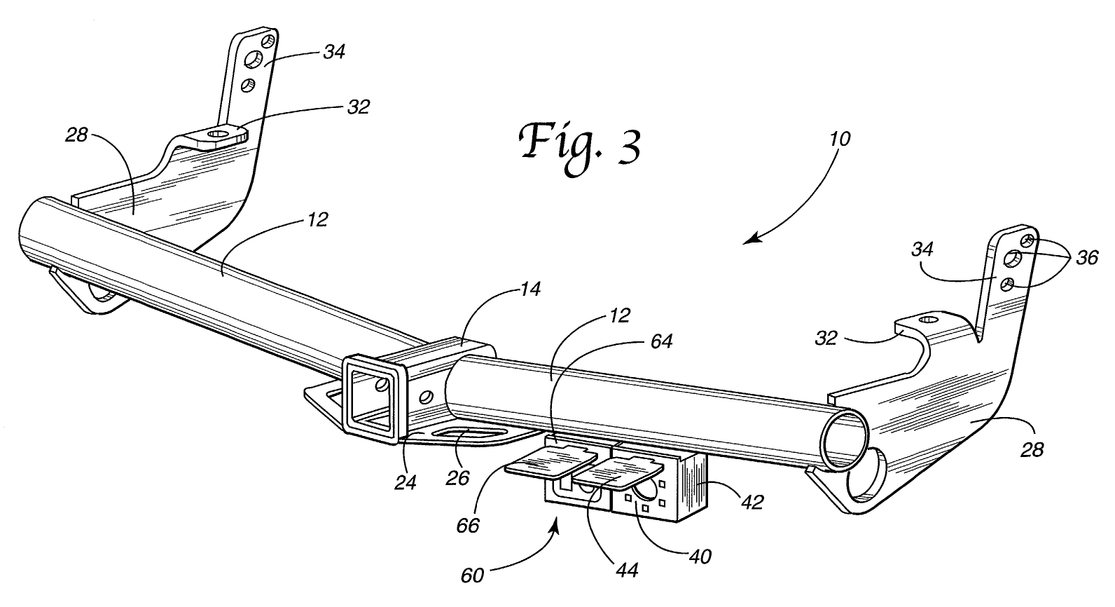

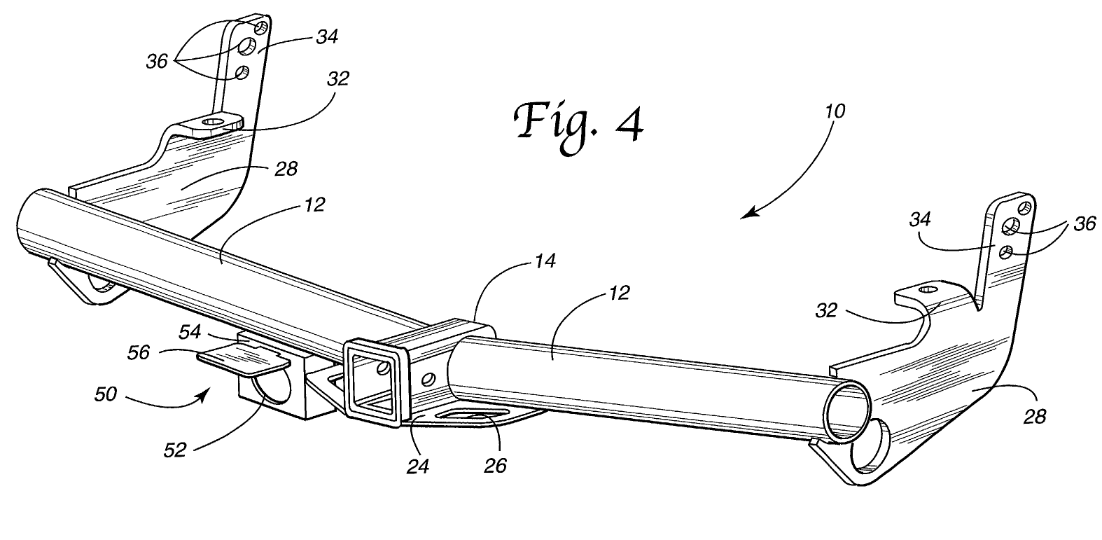

The foregoing description of a preferred embodiment of the invention has been presented for purposes of illustration and description. It is not intended to be exhaustive or to limit the invention to the precise form disclosed. Obvious modifications or variations are possible in light of the above teachings. For example, the trailer hitch assembly 10 may be equipped with only a DC utility power outlet 50 as shown in FIG. 3 or only an AC utility power outlet 60 as shown in FIG. 4. Further, the trailer hitch assembly 10 itself may be of a different overall architecture or design including, for example, a single cross member in place of the two sections 12 carrying a receiver box 14 on top of, in or below that single cross member. Still further, the DC utility power outlet 60 could be connected to a separate storage battery rather than the vehicle battery. Alternatively, the AC power outlet 50 could be connected to a dedicated electric generator carried on the towing vehicle rather than the vehicle motor. Further, the covers 56, 66 on the boxes 54, 64 could include locks to allow them to be secured in the closed position to prevent someone from tapping into the power supply provided by the outlets 50, 60.

The embodiment was chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled.

In the claims

1. A trailer hitch receiver assembly for towing a trailer behind a towing vehicle, comprising:
a frame member including a hitch receiver box;
at least one mounting bracket carried on said frame member for securing said frame member to the vehicle; and
a DC utility power outlet.

2. The trailer hitch receiver assembly of claim 1, wherein said DC utility power outlet is carried on said frame member.

3. The trailer hitch receiver assembly of claim 2, wherein said DC utility power outlet includes a hinged cover.

4. A trailer hitch receiver assembly for towing a trailer behind a towing vehicle, comprising:
a frame member including a hitch receiver box;
at least one mounting bracket carried on said frame member for securing said frame member to the vehicle; and
an AC utility power outlet.

5. The trailer hitch receiver assembly of claim 4, wherein said AC utility power outlet is carried on said frame member.

6. The trailer hitch receiver assembly of claim 4, wherein said AC utility power outlet includes a hinged cover.

7. A trailer hitch receiver assembly for towing a trailer behind a towing vehicle, comprising:
a frame member including a hitch receiver box;
at least one mounting bracket carried on said frame member for securing said frame member to the vehicle;
a DC utility power outlet; and
an AC utility power outlet.

8. The trailer hitch receiver assembly of claim 7, wherein said DC and AC utility power outlets are carried on said frame member.

9. The trailer hitch receiver assembly of claim 7, wherein said DC utility power outlet is carried on said frame member on a first side of said receiver box and said AC utility power outlet is carried on said frame member on a second side of said receiver box.

10. The trailer hitch receiver assembly of claim 7, wherein each of said DC and AC utility power outlets includes a hinged cover.

11. A method of powering an electrical device from a trailer hitch receiver assembly, comprising:
providing a trailer hitch receiver assembly with a utility power outlet; and
powering said utility power outlet from said towing vehicle to which the trailer hitch assembly is connected.

12. The method of claim 11, including powering said utility power outlet with 12 volt DC power from a battery of the towing vehicle.

13. The method of claim 11, including powering said utility outlet with 110 volt AC power from a power invertor on the towing vehicle.
